(19) United States
(12) Patent Application Publication
(10) Pub. No.: US 2007/0054247 A1
(43) Pub. Date: Mar. 8, 2007

(54) Decimal-Point 1/16™

(76) Inventor: Francisco Castruita, Midland, TX (US)

Correspondence Address: Francisco Castruita, 710 S FT. WORTH, MIDLAND, TX, 79701, US

(21) Appl. No.: 10/958,147

(22) Filed: Apr. 12, 2005

(51) Int. Cl. G09B 19/02

(52) U.S. Cl. 434/196

(57) ABSTRACT

The Decimal-Point 1/16™ it's a readout for the tape measure with the scale graduation marked and 16ths of an inch, it's a sticker that sticks to the side of the tape measure, and shows what each scale equals, with this readout any person can learn the fractions and the decimals of an inch. The Decimal-Point 1/16 defining fractional increments of the linear standard unit of the measure, how it shows on the FIGS. Every enclose number demonstrate the rest of the fractions and decimals of an inch.

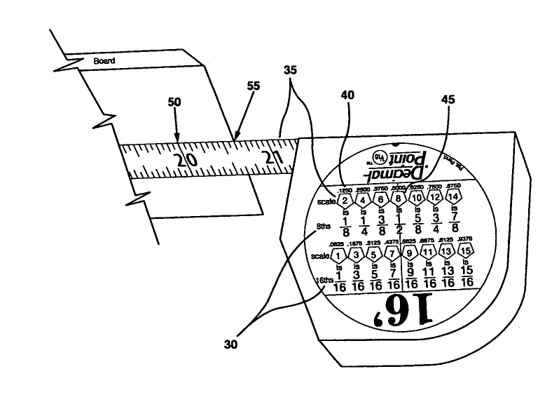

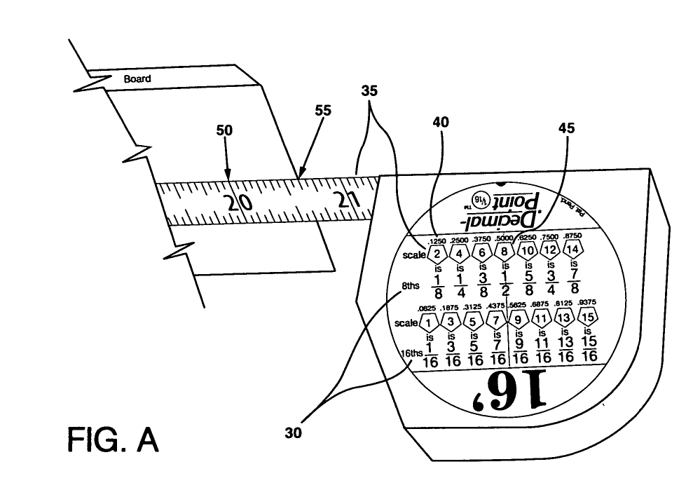

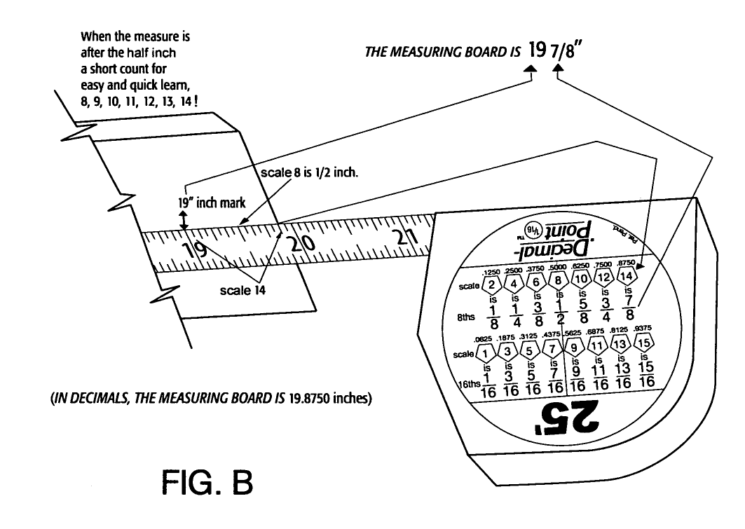

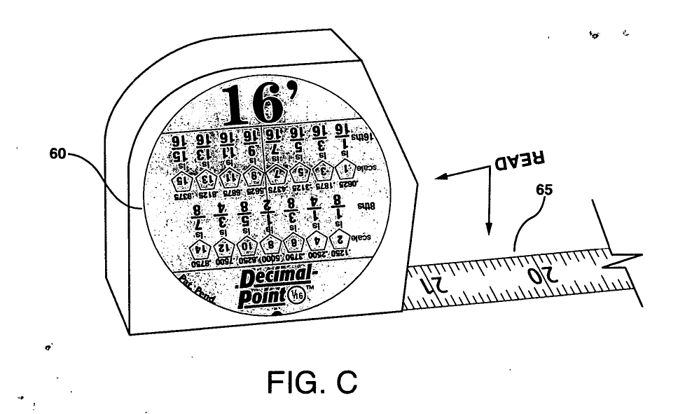

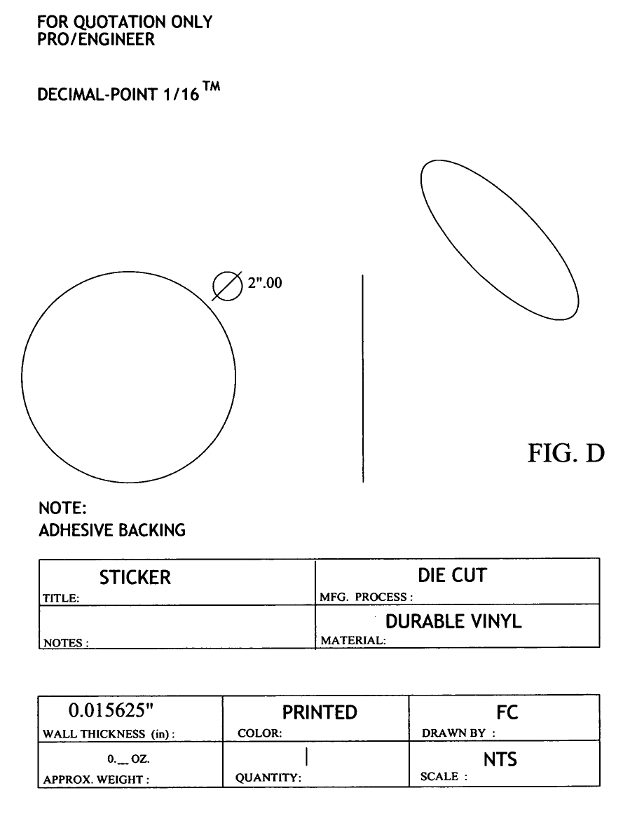

### NEW DISCOVERY!

Have you ever had a tough time reading a tape measure? Often times, it can be difficult to determine what the hatch marks are equivalent to. With the Decimal-Point 1/16 you can have the help you need! It is a readout that sticks to the side of the tape measure and shows what each space equals. You won't have to guess anymore!

### HOW IS IT MADE?

Through countless hours of design strategy implementation, we have accomplished our goal: a cost effective and easy to manufacture product. It is a die cut vinyl sticker. A prototype product sample has been build and Pro Engineer technical drawings are available.

### NEW DISCOVERY?

Have you ever had a tough time reading a tape measure? Often times, it can be difficult to determine what the hatch marks are equivalent to. With the Decimal-Point 1/16™, you can have the help you need! it is a readout that sticks to the side of the tape measure and shows what each space equals. You won't have to guess anymore!

### DETAILS DESCRIPTION OF THE INVENTION

Through countless hours of design strategy implementation, I have accomplish my goal: a cost effective and easy to manufacture product. It is a die cut vinyl sticker. A prototype product sample has been build and Pro Engineer technical drawings are available.

### DESCRIPTION OF THE DRAWINGS

Inch divided into 16ths of an inch.

On the DECIMAL-POINT 1/16 the number enclose represent the scales number of an inch, the fractions of an inch are located underneath the enclose numbers, and the decimals of an inch are located above the enclose numbers:

FIG. A 30, Represents fractions of an inch. 35, are scales of an inch. 40, is decimals of an inch. 45, enclose number and scale eight equal half inch and 0.5000 inches decimals. Example to read the measuring, on the arrow 50 is 20 inch mark, on the arrow 55 is ten scale lines where the board end, and underneath the number ten enclose is the correct fraction that is ⅝ of an inch, so the measuring board is 20 inches and ⅝ of inch (20 ⅝″) (in decimals the measuring board is 20.6250 inches, how it shows on the FIG. A.)

FIG. B Instructional drawing.

FIG. C 60, the right position to stick the Decimal-Point 1/16 on the tape measure. 65, inches scale graduation tape Measure.

FIG. D Professional engineer technical drawing.

1. My Decimal-Point 1/16™ its accuracy readout for teaching fractions and decimals of an inch, initiate from 1/16″ inch and 0.0625″ inches decimals, its a readout that sticks to the side of the tape measure and shows 16ths 8ths and decimals of an inch, its for the tape measure with the graduation marked and 16ths equal spaces of an inch, is easy to determine what each little hatch mark is. It's perfect teaching for carpenters, workshops, students, amateur of homes and office, it didn't exist so I had it made for us. The mathematical and ornamental design of a Decimal-Point 1/16™ as shown and described the professional result.
